(19) United States
(12) Patent Application Publication
(10) Pub. No.: US 2017/0225969 A1
(43) Pub. Date: Aug. 10, 2017

(54) POROUS ORGANIC POLYMERS FOR BINDING HEAVY METALS

(71) Applicant: UNIVERSITY OF SOUTH FLORIDA, Tampa, FL (US)

(72) Inventors: SHENGQIAN MA, TAMPA, FL (US); BAIYAN LI, TAMPA, FL (US)

(73) Assignee: University of South Florida, Tampa, FL (US)

(21) Appl. No.: 15/503,526

(22) PCT Filed: Jul. 22, 2015
(86) PCT No.: PCT/US15/41536

§ 371 Date: Feb. 13, 2017

Related U.S. Application Data
(60) Provisional application No. 62/039,153, filed on Aug. 19, 2014.

(51) Int. Cl. C02F 1/28; B01J 20/28; B01J 20/26

(52) U.S. Cl. CPC C02F 1/285; B01J 20/267; B01J 20/28059; B01J 20/28061; B01J 20/28064; B01J 20/28066; B01J 20/2808; B01J 20/28083; C02F 2101/103

(57) ABSTRACT

Compositions containing a porous organic polymer and a heavy metal chelating moiety are provided for binding heavy metals, for example in remediation and purification. The compositions can be stable and recyclable. The compositions can contain heavy metal chelating moieties such as a thiol, a sulfide, an amine, a pyridine, or a combination thereof. The compositions can bind heavy metals such as lead, cadmium, and mercury. The compositions can have a large surface area greater than about 20 m²/g. The compositions can be used for remediation and purification to remove heavy metals from a solution. The compositions can have a maximum metal uptake capacity of more than 500 mg g⁻¹ and/or a metal distribution coefficient of at least 1×10⁷ mL g⁻¹ at 1 atm and 296 K. Methods of making the compositions are provided. Methods of binding heavy metals in remediation and purification are also provided.

### CROSS-REFERENCE TO RELATED APPLICATIONS

This application claims priority to U.S. Ser. No. 62/039,153 filed Aug. 19, 2014.

### FIELD OF THE DISCLOSURE

The disclosure is generally in the field porous materials for binding heavy metals, for example for use in remediation and purification.

### BACKGROUND OF THE DISCLOSURE

Many industries produce wastewater containing heavy metals such as mercury, lead, cadmium, silver, copper, and zinc. Furthermore, many metal catalysts are used in the chemical synthesis of specialty chemicals and pharmaceuticals. However, exposure to heavy metals can be harmful even at very low metal contaminant concentrations. Heavy metal contamination poses serious threats to public health and the environment. Existing technology to remove heavy metal contaminants can be expensive and/or inadequate to meet stringent regulatory requirements for maximum tolerated levels.

The toxicities of heavy metals are well known. Lead (II), for example, can lead to brain damage and dysfunction of kidneys, liver and central nervous system in humans, especially in children. Cadmium is another toxic metal of environmental concern; it causes kidney, liver and lung damage, and is a probable human carcinogen for lung and hormone-related cancers. Mercury (Hg) pollution can cause birth defects, brain damage, and disease in humans and other species.

The release of mercury into environments is mainly through discharge from industry products/byproducts and processes, such as chemicals, electronic materials, batteries, and fossil fuel combustion. A global agreement has recently been reached aiming at reducing mercury's threat, which spurs the research needed to remove and recover mercury ions from industry waste water. The United States Environmental Protection Agency (EPA) has mandated an upper limit of 2 ppb for mercury in drinking water, and even much lower limits have been strictly regulated for the discharge of mercury into aquatic systems in order to protect ecosystems.

Significant efforts have been devoted to the development of new technology for water treatment. However, inexpensive, efficient, safe, and rapid removal of metal contaminants from water remains a major challenge. Various technologies, such as precipitation, adsorption, chelation, ion-exchange and reverse osmosis, have been developed to treat water contaminated with metal species.

The removal of toxic metals from aqueous streams has traditionally been accomplished via precipitation. In general, this method suffers from the need for long interaction time, high costs for the materials needed for precipitation, and the high cost for disposal of the precipitated material. It is also difficult to reduce the metal concentrations to very low levels by using precipitation.

Among technologies developed for heavy metal removal, adsorption holds great promise due to the simplicity and relatively low-cost of adsorption technology as well as the effectiveness of adsorption method to purify water. A variety of adsorbents have been developed and tested for removing Hg(II) from contaminated waters. Conventional adsorbents such as activated carbons, zeolites, and clays generally have low capacity and weak binding affinity for mercury. Recently, metal-organic frameworks (MOFs) have been explored as a new type of adsorbents for mercury removal due to their high surface areas, but they usually suffer from instability in water or aqueous solutions with a wide pH range and possess low adsorption capacity and weak affinity for Hg(II). Adsorbent materials still face challenges such as the low surface area and low capacity and moderate affinity for heavy metals such as Hg(II) and poor stability in a wide pH range, which have largely limited their effectiveness and efficiency.

Conventional ion-exchange resins are poor candidates for toxic metal removal from water, because they also indiscriminately adsorb nonhazardous ions that are abundant in water, such as Na⁺, K⁺, and Ca²⁺.

Reverse osmosis techniques have been employed in certain applications to remove metal contaminants from water. However, this method is costly, nonselective (all ions are removed), and slow, which makes it unsuitable for large-scale water treatment.

Over the past decade, advanced porous materials such as metal-organic frameworks (MOFs) and porous organic polymers (POPs) [e.g. porous aromatic frameworks (PAFs), conjugated microporous polymers (CMPs), porous polymer networks (PPNs), porous organic frameworks (POFs)] have been explored as new classes of solid adsorbents for applications in gas storage, gas separation, carbon capture, catalysis, etc. In comparison with MOFs, POPs, despite the amorphous nature for most of them, lack preferential binding sites for heavy metals leading to poor metal uptake capacity.

There remains a need for improved heavy metal adsorbents that have high metal uptake capacities and that are stable over a broad range of conditions.

It is an object of this disclosure to provide improved porous materials for heavy metal adsorbents.

It is an additional object of this disclosure to provide materials with high heavy metal uptake capacities.

It is a further object of this disclosure to provide materials with high selectivities for specific heavy metals.

It is an additional object of this disclosure to provide materials that are stable over a broad range of conditions.

It is also an object of this disclosure to provide methods of making improved porous materials for heavy metal adsorbents.

An object of this disclosure is also to provide methods of using porous materials for heavy metal adsorbents to bind heavy metals, for example in remediation and purification.

### SUMMARY

Compositions for binding heavy metals are provided. The compositions can contain a porous organic polymer having incorporated therein a plurality of metal chelator moieties. The porous organic polymer can be a conjugated microporous polymer, a porous aromatic framework, a porous polymer network, or a porous organic framework. For example, the porous organic polymer can be a porous aromatic framework such as cross-linked poly-tetraphenylmethane. The porous organic polymer can contain aryl moieties such as substituted and unsubstituted benzene, naphthalene, anthracene, biphenyl, pyridine, pyrimidine, pyridazine, pyrazine and triazine.

The compositions can be used to effectively bind heavy metals, such as for recovery or remediation purposes. The heavy metals can include metals such as antimony, arsenic, barium, cadmium, chromium, cobalt, copper, gold, lead, mercury, nickel, palladium, platinum, rhodium, selenium, silver, thallium, and zinc. The composition can have a maximum metal uptake capacity of 500 mg g⁻¹ to 2000 mg g⁻¹ at 1 atm and 296 K. The compositions can have a distribution coefficient for the heavy metal of 1×10⁷ mL g⁻¹ to 1×10⁹ mL g⁻¹ at 296 K. The compositions can attain at least 90% of the equilibrium uptake capacity within less than 10 minutes when placed in aqueous solution containing the heavy metal. The metal uptake capacity can be stable and recyclable.

The compositions, including the porous organic polymer, can have a surface area from 20 m²/g to 8,000 m²/g. The compositions can have a pore size from 1 angstrom to 500 angstroms. The compositions can be stable, for example stable in aqueous conditions and/or stable in basic conditions.

The porous organic polymer can contain metal chelator moieties, such as a thiol, a sulfide, an amine, or a pyridine moiety. In some embodiments a composition for olefin separation is provided containing a cross-linked poly-tetraphenylmethane that has been grafted with thiol groups.

Methods of making the compositions described herein are provided. The methods can include synthesizing a porous organic polymer; grafting heavy metal chelator moieties onto the porous organic polymer.

Methods of binding heavy metals are provided. The methods can include contacting the solution with an effective amount of the compositions provided to remove the heavy metal. The solution can contain a high initial concentration of the heavy metal, such as about 1 ppm to 100 ppm, that can be reduced using the compositions provided herein to about 0.2 ppb to 2.0 ppb. The methods can be effective even in the presence of background metals such as calcium, zinc, magnesium, and sodium. The methods can be effective even under extreme pH conditions such as acid pH of about 1.0 to 3.0 or basic pH of about 11.0 to 13.0.

### BRIEF DESCRIPTION OF THE DRAWINGS

FIG. 1 is a schematic illustration of creating a mercury “nano-trap” for Hg(II) removal from water by functionalizing a highly porous framework with mercury chelating groups.

FIG. 2 is a graph of the experimental FT-IR spectral of PAF-1 (upper curve) and PAF-1-SH (lower curve) with a line around 2576 cm⁻¹ highlighting the small peak associated with the —SH stretching frequency in the latter.

FIG. 3 is a graph of the experimental XPS spectra of PAF-1-SH demonstrating a peak with a binding energy at 163.8 eV attributed to the sulfur

FIG. 4 is a graph of the solid state ¹³C NMR spectra of PAF-1-SH demonstrating chemical shifts at 23.0 and 28.9 ppm for the carbon of —CH₂ group.

FIG. 5 is a graph of N₂ sorption isotherms at 77 K for cross-linked poly-tetraphenylmethane (PAF-1) (squares) and thiol-grafted PAF-1 (PAF-1-SH) (circles). Filled: adsorption; unfilled: desorption.

FIG. 6 is a graph of the pore size distribution of cross-linked poly-tetraphenylmethane (PAF-1) (squares) and thiol-grafted PAF-1 (PAF-1-SH) (circles) determined using the Horvath-Kawazoe model.

FIG. 7 is a graph of the by Energy-dispersive X-ray spectroscopy (EDS) spectra of mercury absorbed on thiol-grafted cross-linked poly-tetraphenylmethane (Hg(II)@PAF-1-SH) demonstrating the absorbed Hg(II) signal and the S from the thio group (the Cu signal is from the copper support).

FIG. 8 is a graph of the mercury adsorption kinetics of thiol-grafted cross-linked poly-tetraphenylmethane (PAF-1-SH) (25.0 mg) in an initial 10 ppm solution (pH of 6.8) of Hg(NO₃)₂ (50.0 ml) plotted as Hg(II) concentration (ppb) as a function of time (hours).

FIG. 9 is a graph of absorption of Hg(II) (mg g⁻¹) versus contact time (min) for thiol-grafted cross-linked poly-tetraphenylmethane (PAF-1-SH) in an initial 10 ppm solution (pH of 6.8) of Hg(NO₃)₂ (50.0 ml) (inset: plot of t/qₜ versus t demonstrating the pseudo-second-order adsorption kinetics).

FIG. 10 is a graph of absorbed Hg(II) (mg g⁻¹) as a function of equilibrium Hg(II) concentration (mg L⁻¹) for an aqueous solution of thiol-grafted cross-linked poly-tetraphenylmethane (PAF-1-SH) (inset: graph of the linear regression by fitting the equilibrium adsorption data with Langmuir adsorption model

FIG. 11 is a graph of N₂ sorption isotherms at 77 K for thiol-grafted PAF-1 (PAF-1-SH) before (triangles) and after (circles) treatment successively with 2.0 M NaOH, 2.0 M HCl and boiling water. Filled: adsorption; unfilled: desorption.

FIG. 12 is a set of bar graphs depicting the Hg(II) concentration (ppb) in an aqueous solution of Hg(NO₃)₂ prior to (left bar) and after (right bar) treatment with thiol-grafted cross-linked poly-tetraphenylmethane (PAF-1-SH) as a function of pH (pH values of 1.0, 6.8, and 12.8).

FIG. 13 is set of bar graphs depicting the Hg(II) loading capacity (mg/g) of thiol-grafted cross-linked poly-tetraphenylmethane (PAF-1-SH) as a function of the number of regeneration cycles.

FIG. 14 is a graph of the IR spectra of thiol-grafted cross-linked poly-tetraphenylmethane (PAF-1-SH); PAF-1-SH with adsorbed Hg(II) (Hg(II)@PAF-1-SH) and PAF-1-SH after three regeneration cycles (regenerated

FIG. 15 is a graph of the FT-IR spectra of thiol-grafted cross-linked poly-tetraphenylmethane (PAF-1-SH) (top curve) and Hg(II)-loaded PAF-1-SH (bottom curve).

FIG. 16 is a graph of the solid state ¹³C NMR of thiol-grafted cross-linked poly-tetraphenylmethane (PAF-1-SH) (bottom curve) and Hg(II)-loaded PAF-1-SH (top curve).

FIG. 17 is a graph of the photoluminescence spectra of thiol-grafted cross-linked poly-tetraphenylmethane (PAF-1-SH) (top curve) and Hg(II)-loaded PAF-1-SH (bottom curve).

FIG. 18 is a graph comparing the Hg(II) saturation uptake amount (mg g⁻¹) and K_{d} value (mg L⁻¹) for thiol-grafted cross-linked poly-tetraphenylmethane (PAF-1-SH) with other benchmark materials.

FIG. 19 is a graph of the thermogravimetric analysis (TGA) of thiol-grafted cross-linked poly-tetraphenylmethane (PAF-1-SH).

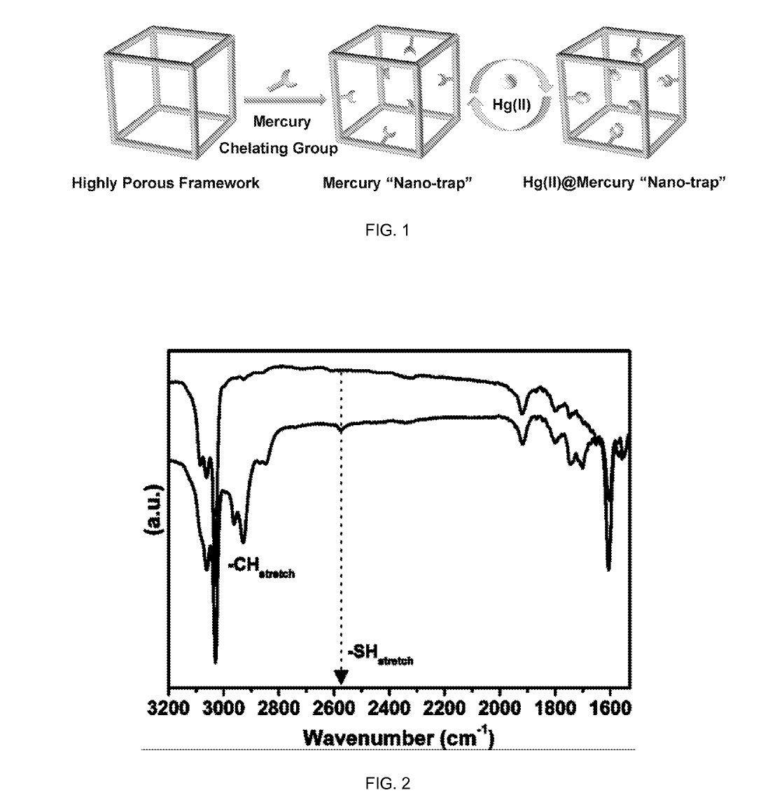

### DETAILED DESCRIPTION

Compositions for binding a heavy metal are provided. The compositions can have a porous organic polymer having incorporated therein a plurality of heavy metal chelator moieties. The compositions can have one or both of a large maximum heavy metal uptake capacity and a large heavy metal distribution coefficient. The compositions can be stable and recyclable, and can be useful for binding heavy metals in a variety of applications such as remediation and purification. Methods of making the compositions and methods of using the compositions are also provided.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In some embodiments, the term “about” can include traditional rounding according to significant figures of the numerical value. In addition, the phrase “about ‘x’ to ‘y’” includes “about ‘x’ to about ‘y’”.

### I. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The terms “pore diameter” and “pore size”, as used interchangeably herein, refer to a measure of the effective diameter of the pores in the composition. The pore diameter can be the effective diameter of the largest gas molecule that can pass through the majority of the pores in the composition. The pore diameter can be estimated from the average pore diameter obtained from crystallographic measurements. The pore diameter can be estimated from measured adsorption isotherms for an inert gas such as N₂ using models such as the Horvath-Kawazoe model.

The term “conjugated microporous polymer (CMP)”, as used herein, refers to a class of ultrahigh surface area materials characterized by an amorphous structure made through coupling of aromatic monomers leading to extended conjugation. The extended conjugation of a conjugated microporous polymer can lead to the formation of electronic bands much like those found in conductive metals. A conjugated microporous polymer can have a surface area from about 300 m²/g to about 2,000 m²/g, about 400 m²/g to about 1500 m²/g, or about 500 m²/g to about 3000 m²/g.

The term “porous aromatic framework (PAF)”, as used herein, refers to a class of ultrahigh surface area materials characterized by a rigid aromatic open-framework structure constructed by covalent bonds. Porous aromatic frameworks lack the extended conjugation found in conjugated microporous polymers. A porous aromatic framework can have a surface area from about 500 m²/g to about 7,000 m²/g, about 1,000 m²/g to about 6,000 m²/g, or about 1,500 m²/g to about 5,000 m²/g.

The terms “porous polymer network (PPN)” and “interpenetrating polymer network (IPN)”, as used interchangeably herein, refer to a class of high surface area materials containing at least two polymers, each in network form wherein at least one of the polymers is synthesized and/or crosslinked in the presence of the other. The polymer networks are physically entangled with each other and in some embodiments may be also be covalently bonded. Porous polymer networks can have a surface area from about 20 m²/g to about 6,000 m²/g, about 40 m²/g to about 500 m²/g, or about 80 m²/g to about 400 m²/g.

The terms “porous organic framework (POF)” and “covalent organic framework (COF)”, as used interchangeably herein, refer to a class of highly crystalline, high surface area materials formed of small organic building blocks made entirely from light elements (H, B, C, N, and O) that are known to form strong covalent bonds. Porous organic frameworks can have a surface area from about 100 m²/g to about 5,000 m²/g, about 150 m²/g to about 4,000 m²/g, or from about 300 m²/g to about 3,000 m²/g.

The term “porous organic polymer (POP)”, as used herein, refers generally to high surface area materials formed from organic segments covalently bonded to form an extended porous structure. Porous organic polymers can include conjugated microporous polymers, porous aromatic frameworks, porous polymer networks, and porous organic frameworks. The porous organic polymer can be crystalline, semi-crystalline, or amorphous. The porous organic polymer can have a surface greater than about 20 m²/g, 50 m²/g, 100 m²/g, 500 m²/g, or greater than about 1,000 m²/g. The porous organic polymer can have a surface area up to about 8,000 m²/g, 7,000 m²/g, 6,000 m²/g, 5,000 m²/g, or 4,000 m²/g. As used herein, the term “porous organic polymer” does not include zeolite structures or mesoporous silica structures.

The term “stable”, as used herein, refers to compositions that are stable over time, stable under aqueous conditions, stable under harsh conditions, stable under acidic conditions, and/or stable under basic conditions. A composition is stable over time when, under standard operating conditions such as elevated temperatures and/or pressures, the composition does not change pore size by more than 1%, 2%, 5%, or 10% and/or does not change maximum metal uptake capacity by more than 1%, 2%, 5%, or 10% for a period of at least 1, 2, 10, 20, or 30 days. A composition is stable under harsh conditions when the composition does not change pore size by more than 1%, 2%, 5%, or 10% after exposure to boiling water for at least 2, 3, 4, 5, or 6 hours. A composition is stable under harsh conditions when the composition has a distribution coefficient of the heavy metal that is greater than 1×10⁶ mL g⁻¹, greater than 5×10⁶ mL g⁻¹, greater than 1×10⁷ mL g⁻¹, or greater than 2×10⁷ mL g⁻¹ both under acidic conditions of pH less than 3.0, 2.0, or 1.0 and under basic conditions of pH great than 10.0, 11.0, or 12.0. A composition is stable under aqueous conditions when it does not change pore size by more than 1%, 2%, 5%, or 10% and/or does not change maximum metal uptake capacity by more than 1%, 2%, 5%, or 10% after being exposed to an air environment with at least 60%, at least 70%, at least 80%, or at least 90% relative humidity for at least 12 hours or for at least 1, 2, 3, 4, 5, or 10 days. A composition is stable under basic conditions when it does not change pore size by more than 1%, 2%, 5%, or 10% and/or does not change maximum metal uptake capacity by more than 1%, 2%, 5%, or 10% after exposure to concentrated NaOH solution, e.g. at least 1.0 M, 2.0M, 3.0 M, or 6.0 M NaOH, for a period of at least 120 minutes. A composition is stable under acid conditions when it does not change pore size by more than 1%, 2%, 5%, or 10% and/or does not change maximum metal uptake capacity by more than 1%, 2%, 5%, or 10% after exposure to concentrated HCl solution, e.g. at least 1.0 M, 2.0M, 3.0 M, or 6.0 M HCl, for a period of at least 120 minutes.

The term “small molecule”, as used herein, generally refers to an organic molecule that is less than about 2,000 g/mol in molecular weight, less than about 1,500 g/mol, less than about 1,000 g/mol, less than about 800 g/mol, or less than about 500 g/mol. Small molecules are non-polymeric and/or non-oligomeric.

The term “derivative” refers to any compound having the same or a similar core structure to the compound but having at least one structural difference, including substituting, deleting, and/or adding one or more atoms or functional groups. The term “derivative” does not mean that the derivative is synthesized from the parent compound either as a starting material or intermediate, although this may be the case. The term “derivative” can include salts, prodrugs, or metabolites of the parent compound. Derivatives include compounds in which free amino groups in the parent compound have been derivatized to form amine hydrochlorides, p-toluene sulfoamides, benzoxycarboamides, t-butyloxycarboamides, thiourethane-type derivatives, trifluoroacetylamides, chloroacetylamides, or formamides. Derivatives include compounds in which carboxyl groups in the parent compound have been derivatized to form salts, methyl and ethyl esters or other types of esters or hydrazides. Derivatives include compounds in which hydroxyl groups in the parent compound have been derivatized to form O-acyl or O-alkyl derivatives. Derivatives include compounds in which a hydrogen bond donating group in the parent compound is replaced with another hydrogen bond donating group such as OH, NH, or SH. Derivatives include replacing a hydrogen bond acceptor group in the parent compound with another hydrogen bond acceptor group such as esters, ethers, ketones, carbonates, tertiary amines, imine, thiones, sulfones, tertiary amides, and sulfides.

The terms “reactive coupling group” and “reactive functional group” are used interchangeably herein to refer to any chemical functional group capable of reacting with a second functional group under the given conditions to form a covalent bond. Those skilled in the art will recognize that some functional groups may react under certain conditions but not under others. Accordingly, some functional groups may be reactive coupling groups only certain conditions, e.g. under conditions where the groups react to form a covalent bond. The selection of reactive coupling groups is within the ability of the skilled artisan. Examples of reactive coupling groups can include primary amines (—NH₂) and amine-reactive linking groups such as isothiocyanates, isocyanates, acyl azides, NHS esters, sulfonyl chlorides, aldehydes, glyoxals, epoxides, oxiranes, carbonates, aryl halides, imidoesters, carbodiimides, anhydrides, and fluorophenyl esters. Most of these conjugate to amines by either acylation or alkylation. Examples of reactive coupling groups can include aldehydes (—COH) and aldehyde reactive linking groups such as hydrazides, alkoxyamines, and primary amines. Examples of reactive coupling groups can include thiol groups (—SH) and sulfhydryl reactive groups such as maleimides, haloacetyls, and pyridyl disulfides. Examples of reactive coupling groups can include photoreactive coupling groups such as aryl azides or diazirines. Examples of reactive coupling groups can include click reactive coupling groups capable of forming covalent bonds through click reactions. Well-known reactions include the hetero-Diels-Alder reaction, the thiol-ene coupling, the Staudinger ligation, native chemical ligation, and the amidation reaction between thio acids or thio esters and sulfonyl azides (referred to as ‘sulfo-click’). As used herein, the terms “sulfo-click” and “sulfo-click chemistry” are used to refer to a reaction between thio acids and sulfonyl azides containing molecules, creating a covalent bonds between the two molecules. Examples of sulfo-click chemistry are described in U.S. Patent Application Publication 2011/0130568 and PCT Publication WO 2012/021486. The coupling reaction may include the use of a catalyst, heat, pH buffers, light, or a combination thereof.

The term “alkyl” refers to the radical of saturated aliphatic groups (i.e., an alkane with one hydrogen atom removed), including straight-chain alkyl groups, branched-chain alkyl groups, cycloalkyl (alicyclic) groups, alkyl-substituted cycloalkyl groups, and cycloalkyl-substituted alkyl groups.

In preferred embodiments, a straight chain or branched chain alkyl has 30 or fewer carbon atoms in its backbone (e.g., C₁-C₃₀ for straight chains, and C₃-C₃₀ for branched chains), preferably 20 or fewer, more preferably 15 or fewer, most preferably 10 or fewer. Likewise, preferred cycloalkyls have 3-10 carbon atoms in their ring structure, and more preferably have 5, 6, or 7 carbons in the ring structure. The term “alkyl” (or “lower alkyl”) as used throughout the specification, examples, and claims is intended to include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, phosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

Unless the number of carbons is otherwise specified, “lower alkyl” as used herein means an alkyl group, as defined above, but having from one to ten carbons, more preferably from one to six carbon atoms in its backbone structure. Likewise, “lower alkenyl” and “lower alkynyl” have similar chain lengths. Throughout the application, preferred alkyl groups are lower alkyls. In preferred embodiments, a substituent designated herein as alkyl is a lower alkyl.

It will be understood by those skilled in the art that the moieties substituted on the hydrocarbon chain can themselves be substituted, if appropriate. For instance, the substituents of a substituted alkyl may include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

The term “heteroalkyl”, as used herein, refers to straight or branched chain, or cyclic carbon-containing radicals, or combinations thereof, containing at least one heteroatom. Suitable heteroatoms include, but are not limited to, O, N, Si, P, Se, B, and S, wherein the phosphorus and sulfur atoms are optionally oxidized, and the nitrogen heteroatom is optionally quaternized. Heteroalkyls can be substituted as defined above for alkyl groups.

The term “alkylthio” refers to an alkyl group, as defined above, having a sulfur radical attached thereto. In preferred embodiments, the “alkylthio” moiety is represented by one of —S-alkyl, —S-alkenyl, and —S-alkynyl. Representative alkylthio groups include methylthio, ethylthio, and the like. The term “alkylthio” also encompasses cycloalkyl groups, alkene and cycloalkene groups, and alkyne groups. “Arylthio” refers to aryl or heteroaryl groups. Alkylthio groups can be substituted as defined above for alkyl groups.

The terms “alkenyl” and “alkynyl”, refer to unsaturated aliphatic groups analogous in length and possible substitution to the alkyls described above, but that contain at least one double or triple bond respectively.

The terms “alkoxyl” or “alkoxy” as used herein refers to an alkyl group, as defined above, having an oxygen radical attached thereto. Representative alkoxyl groups include methoxy, ethoxy, propyloxy, tert-butoxy and the like. An “ether” is two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. The terms “aroxy” and “aryloxy”, as used interchangeably herein, can be represented by —O-aryl or O-heteroaryl, wherein aryl and heteroaryl are as defined below. The alkoxy and aroxy groups can be substituted as described above for alkyl.

The terms “amine” and “amino” (and its protonated form) are art-recognized and refer to both unsubstituted and substituted amines, e.g., a moiety that can be represented by the general formula:

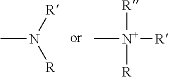

wherein R, R′, and R″ each independently represent a hydrogen, an alkyl, an alkenyl, —(CH2)ₘ-R_{c} or R and R′ taken together with the N atom to which they are attached complete a heterocycle having from 4 to 8 atoms in the ring structure; R_{c} represents an aryl, a cycloalkyl, a cycloalkenyl, a heterocycle or a polycycle; and m is zero or an integer in the range of 1 to 8. In preferred embodiments, only one of R or R′ can be a carbonyl, e.g., R, R′ and the nitrogen together do not form an imide. In still more preferred embodiments, the term “amine” does not encompass amides, e.g., wherein one of R and R′ represents a carbonyl. In even more preferred embodiments, R and R′ (and optionally R″) each independently represent a hydrogen, an alkyl or cycloakly, an alkenyl or cycloalkenyl, or alkynyl. Thus, the term “alkylamine” as used herein means an amine group, as defined above, having a substituted (as described above for alkyl) or unsubstituted alkyl attached thereto, i.e., at least one of R and R′ is an alkyl group

The term “amido” is art-recognized as an amino-substituted carbonyl and includes a moiety that can be represented by the general formula:

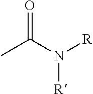

wherein R and R′ are as defined above.

“Aryl”, as used herein, refers to C₅-C₁₀-membered aromatic, heterocyclic, fused aromatic, fused heterocyclic, biaromatic, or bihetereocyclic ring systems. Broadly defined, “aryl”, as used herein, includes 5-, 6-, 7-, 8-, 9-, and 10-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine, pyrimidine, and the like. Those aryl groups having heteroatoms in the ring structure may also be referred to as “aryl heterocycles” or “heteroaromatics”. The aromatic ring can be substituted at one or more ring positions with one or more substituents including, but not limited to, halogen, azide, alkyl, aralkyl, alkenyl, alkynyl, cycloalkyl, hydroxyl, alkoxyl, amino (or quaternized amino), nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, and combinations thereof.

The term “aryl” also includes polycyclic ring systems having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, IH-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl, and xanthenyl. One or more of the rings can be substituted as defined above for “aryl”.

The term “aralkyl”, as used herein, refers to an alkyl group substituted with an aryl group (e.g., an aromatic or heteroaromatic group).

The term “aralkyloxy” can be represented by —O-aralkyl, wherein aralkyl is as defined above.

The term “carbocycle”, as used herein, refers to an aromatic or non-aromatic ring(s) in which each atom of the ring(s) is carbon.

“Heterocycle” or “heterocyclic”, as used herein, refers to a monocyclic or bicyclic structure containing 3-10 ring atoms, and preferably from 5-6 ring atoms, consisting of carbon and one to four heteroatoms each selected from the group consisting of non-peroxide oxygen, sulfur, and N(Y) wherein Y is absent or is H, O, (C₁-C₁₀) alkyl, phenyl or benzyl, and optionally containing 1-3 double bonds and optionally substituted with one or more substituents. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxepanyl, oxetanyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydropyranyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl, and xanthenyl. Heterocyclic groups can optionally be substituted with one or more substituents at one or more positions as defined above for alkyl and aryl, for example, halogen, alkyl, aralkyl, alkenyl, alkynyl, cycloalkyl, hydroxyl, amino, nitro, sulfhydryl, imino, amido, phosphate, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The term “carbonyl” is art-recognized and includes such moieties as can be represented by the general formula:

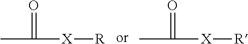

wherein X is a bond or represents an oxygen or a sulfur, and R and R′ are as defined above. Where X is an oxygen and R or R′ is not hydrogen, the formula represents an “ester”. Where X is an oxygen and R is as defined above, the moiety is referred to herein as a carboxyl group, and particularly when R is a hydrogen, the formula represents a “carboxylic acid”. Where X is an oxygen and R′ is hydrogen, the formula represents a “formate”. In general, where the oxygen atom of the above formula is replaced by sulfur, the formula represents a “thiocarbonyl” group. Where X is a sulfur and R or R′ is not hydrogen, the formula represents a “thioester.” Where X is a sulfur and R is hydrogen, the formula represents a “thiocarboxylic acid.” Where X is a sulfur and R′ is hydrogen, the formula represents a “thioformate.” On the other hand, where X is a bond, and R is not hydrogen, the above formula represents a “ketone” group. Where X is a bond, and R is hydrogen, the above formula represents an “aldehyde” group.

The term “heteroatom” as used herein means an atom of any element other than carbon or hydrogen. Preferred heteroatoms are boron, nitrogen, oxygen, phosphorus, sulfur, and selenium. Other heteroatoms include silicon and arsenic

As used herein, the term “nitro” means —NO₂; the term “halogen” designates —F, —Cl, —Br, or —I; the term “sulfhydryl” means —SH; the term “hydroxyl” means —OH; and the term “sulfonyl” means —SO₂—.

The term “substituted” as used herein, refers to all permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, preferably 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, amino acid, peptide, and polypeptide groups.

Heteroatoms such as nitrogen may have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

### II. Compositions for Binding Heavy Metals

Compositions for binding heavy metals are provided. The compositions contain a porous organic polymer having incorporated therein a plurality of metal chelator moieties. The compositions can be stable. For example, the compositions can be stable under aqueous conditions, stable under acidic conditions, stable under basic conditions, stable under high pressure, or a combination thereof. The compositions can be useful for the binding of heavy metals, for example in separation, purification, and remediation processes. There are many porous organic polymers and many heavy metal chelator moieties that may be used. In some embodiments the porous organic polymer is a porous aromatic framework, and the heavy metal chelator is a thiol. For example, the composition can be a cross-linked poly-tetraphenylmethane having thiol groups incorporated therein.

The composition can bind a heavy metal. The term “heavy metal”, as used herein, refers broadly to any metal or metalloid element that is stable and has a high specific gravity and high atomic mass as well as alloys and particles thereof, optionally including additional ligands. The heavy metal can have a specific gravity of about 4, 4.5, 5, 6, 7, 8, 9, 10, 12, 14, 16, 18, 20, or greater. The heavy metal can have an atomic mass of about 40 a.m.u., 50 a.m.u., 60 a.m.u., 70 a.m.u., 80 a.m.u., 90 a.m.u., 100 a.m.u., 120 a.m.u., 140 a.m.u., 160 a.m.u., 180 a.m.u., 190 a.m.u., 200 a.m.u., or greater. The heavy metal can be one that tends to be toxic in low concentrations and tends to accumulate in the food chain. Heavy metals include antimony, arsenic, beryllium, cadmium, chromium, copper, lead, mercury, nickel, selenium, silver, thallium, tin and zinc, and compounds thereof. For purposes of this disclosure, “heavy metals” can also include iron, aluminum, tin, cobalt, gallium, lithium, arsenic, beryllium, vanadium, and other metals and metalloids. The heavy metal mercury is selected as a representative example for describing the removal and management techniques herein.

The compositions can contain a porous organic polymer. Porous organic polymers provide a high surface area and range of pore sizes that can be useful for compositions for binding heavy metals. The porous organic polymer can be a conjugated microporous polymer, a porous aromatic framework, a porous polymer network, or a porous organic framework. The porous organic polymer can be crystalline, semi-crystalline, or amorphous. The porous organic polymer can be stable. For example, the porous organic polymer can be stable under aqueous conditions, stable under acidic conditions, stable under basic conditions, stable under high pressure, or a combination thereof.

The porous organic polymer can be a conjugated microporous polymer, a porous aromatic framework, a porous polymer network, a porous organic framework, or a mesoporous organic polymer. Suitable porous polymers can include fluoropolymers, e.g. polytetrafluoroethylene or polyvinylidene fluorides, polyolefins, e.g. polyethylene or polypropylene; polyamides; polyesters; polysulfone, poly(ethersulfone) and combinations thereof, polycarbonate, polyurethanes. Suitable porous aromatic frameworks can include cross-linked poly-tetraphenylmethane, poly-teraphenyl silane, lo and poly-triphenyl amine polymers.

The porous organic polymer can have any surface are useful for the particular heavy metal. In some embodiments the porous organic polymer will have a surface area of about 200 m²/g, about 400 m²/g, about 600 m²/g, about 800 m²/g, about 1,000 m²/g, about 1,200 m²/g, about 1,400 m²/g, about 1,600 m²/g, about 2,000 m²/g, about 2,500 m²/g, about 3,000 m²/g, or greater. For example, the porous organic polymer can have a surface area from about 200 m²/g to about 8,000 m²/g, from about 400 m²/g to about 7,000 m²/g, from about 600 m²/g to about 6,000 m²/g, from about 1,200 m²/g to about 5,000 m²/g, from about 2,500 m²/g to about 5,000 m²/g, from about 3,000 m²/g to about 5,000 m²/g, or from about 3,000 m²/g to about 4,000 m²/g.

The porous organic polymer can have a range of pore sizes. For example, the pore size can be adjusted to best accommodate particular heavy metals. The porous organic polymer can have a pore size from about 5 Å to about 2,000 Å, from about 5 Å to about 1,500 Å, from about 5 Å to about 1,000 Å, from about 5 Å to about 500 Å. In some embodiments a composition useful for binding heavy metals can have a pore size of about 2 Å to about 200 Å, from about 2 Å to about 100 Å, from about 5 Å to about 50 Å, from about 5 Å to about 25 Å, from about 5 Å to about 25 Å, from about 10 Å to about 25 Å, from about 10 Å to about 20 Å, or about 12 Å.

The porous organic polymer can contain monomer units having an aryl moiety. A variety of porous organic polymers can be made with aryl moieties. For example, the porous organic polymer can contain a monomer unit containing an aryl moiety selected from the group consisting of substituted and unsubstituted benzene, naphthalene, anthracene, biphenyl, pyridine, pyrimidine, pyridazine, pyrazine and triazine.

The porous organic polymer can contain one or more heavy metal chelator moieties. The term heavy metal chelator moiety refers to functional groups capable of preferential binding to a heavy metal and includes monovalent as we a multivalent binding. The heavy metal chelator moiety can be a thiol, a sulfide, an amine, or a pyridine moiety.

In some embodiments the porous organic polymer contains a monomer unit selected from

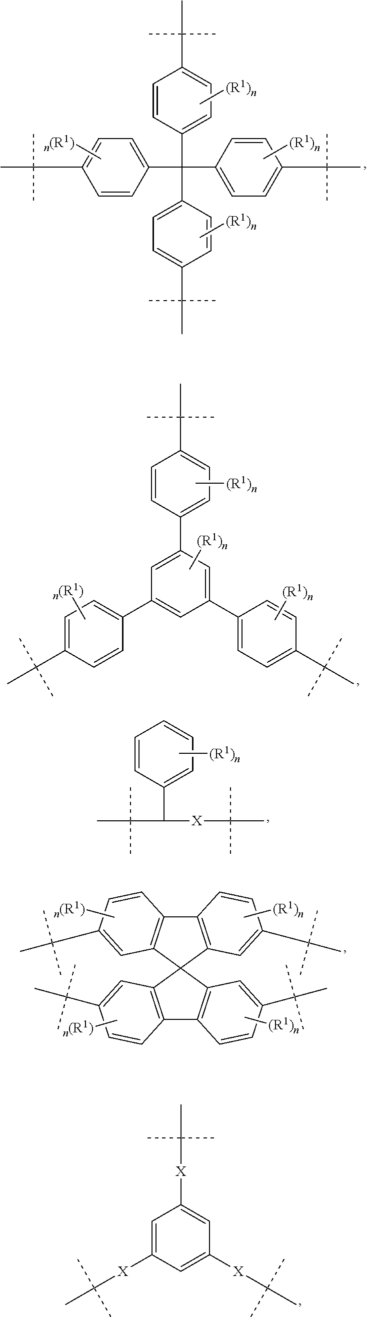

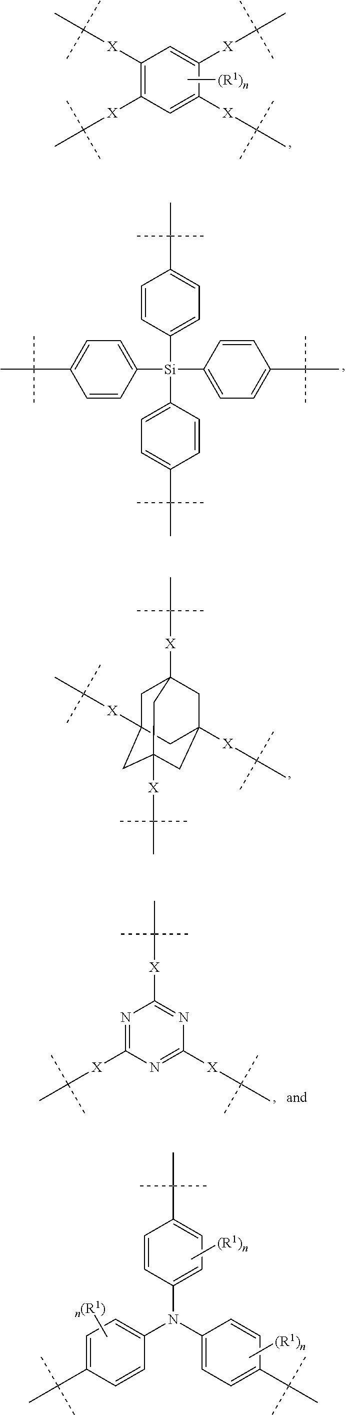

wherein each occurrence of X is independently selected from —CH₂—, phenylene, and —≡—, optionally containing one or more R¹ substituents; wherein each occurrence of R¹ is independently selected from substituted and unsubstituted alkyl, heteroalkyl, alkylthio, alkoxy, amino, and acidic functional groups having from 1 to 20, from 1 to 12, from 1 to 10, or from 1 to 5 carbon atoms; wherein each occurrence of n is an integer 1, 2, 3, or 4. In some embodiments, the porous organic polymer contains monomer units having at least one, at least two, at least three, or at least four heavy metal chelator moieties per monomer unit. Suitable heavy metal chelator moieties can include thiols, sulfides, amines, and pyridines.

The compositions can have large maximum metal uptake capacities, large distribution coefficients for the heavy metal, and/or strong heavy metal binding energies. The compositions can have a maximum metal uptake capacity at 1 atm and 296 K of about 100 mg g⁻¹ to about 10,000 mg g⁻¹, about 200 mg g⁻¹ to about 10,000 mg g⁻¹, about 200 mg g⁻¹ to about 8,000 mg g⁻¹, about 200 mg g⁻¹ to about 6,000 mg g⁻¹, about 300 mg g⁻¹ to about 6,000 mg g⁻¹, about 400 mg g⁻¹ to about 6,000 mg g⁻¹, about 400 mg g⁻¹ to about 5,000 mg g⁻¹, about 500 mg g⁻¹ to about 5,000 mg g⁻¹, about 500 mg g⁻¹ to about 4,000 mg g⁻¹, or about 500 mg g⁻¹ to about 2,000 mg g⁻¹. The compositions can have a distribution coefficient for the heavy metal of about 1×10⁶ mL g⁻¹ to 1×10¹¹ mL g⁻¹, about 3×10⁶ mL g⁻¹ to 1×10¹¹ mL g⁻¹, about 5×10⁶ mL g⁻¹ to 1×10¹¹ mL g⁻¹, about 5×10⁶ mL g⁻¹ to 1×10¹⁹ mL g⁻¹, about 7×10⁶ mL g⁻¹ to 1×10¹⁹ mL g⁻¹, about 1×10⁷ mL g⁻¹ to 1×10¹⁰ mL g⁻¹, about 1×10⁷ mL g⁻¹ to 5×10⁹ mL g⁻¹, or about 1×10⁷ mL g⁻¹ to 1×10⁹ mL g⁻¹.

The compositions can have large heavy metal uptake relative to the uptake capacity of background metal ions. For example, the composition can have a heavy metal uptake capacity that is at least 2, 5, 10, 20, 50, or 100 times larger than the uptake capacity of a background metal ion such as Na⁺, K⁺, or Ca²⁺. The compositions can have large distribution coefficients for the heavy metal relative to the distribution coefficient for background metal ions. For example the compositions can have a distribution coefficient for the heavy metal that is at least 10, 20, 50, 100, 500, or 1,000 times larger than the distribution coefficient for background metal ions such as Na⁺, K⁺, or Ca²⁺.

### III. Methods of Making Compositions for Binding Heavy Metals

Methods of making compositions for binding heavy metals are provided. The methods can include making any of the compositions described above or below. The methods can include (1) synthesizing a porous organic polymer (2) grafting heavy metal chelator moieties onto the porous organic polymer. The methods can include functionalizing the porous organic polymer with a heavy metal chelator moiety such as a thiol, a sulfide, an amine, or a pyridine moiety.

Methods of synthesizing porous organic polymers are known and described, for example, in U.S. Pat. No. 8,470,900; Chakraborty et al., Chem. Sci., 2015, 6:384-389; Zhao et al., Chem. Commun., 2013, 49:2780-2782; Wang et al., Dalton Trans., 2012, 41:3933-3936. In some embodiments porous organic polymers are synthesized according to methods described in Lu et al., J. Am. Chem. Soc. 2011, 133:18126 or slight modifications thereof.

Methods of grafting heavy metal chelator moieties onto polymers are known. For example, the methods can include chloromethylation of the polymer to yield the corresponding benzyl chloride. Other benzyl halides can be synthesized by similar procedures. The methods can include reacting the benzyl chloride or other benzyl halide with sodium hydrosulfide to produce the corresponding thiol functionalized polymer. The reaction can be performed at temperatures of about 20° C. to 100° C., about 25° C. to 90° C., or about 50° C. to 80° C.

### IV. Methods of Binding Heavy Metals

Methods of binding heavy metals are provided. The methods can include using any of the compositions described herein with any solution containing one or more heavy metals. The methods can include contacting the solution containing the heavy metal with an effective amount of any one of the compositions described herein.

In some embodiments the initial concentration of the heavy metal in the solution is is about 0.1 ppm to 1000 ppm, 0.1 ppm to 500 ppm, 1 ppm to 500 ppm, or 1 ppm to 100 ppm. The final concentration of the heavy metal in the solution can be 0.02 ppb to 10 ppb, 0.02 ppb to 5 ppb, 0.1 ppb to 5 ppb, 0.1 ppb to 2 ppb, or 0.2 ppb to 2 ppb.

The solution containing the heavy metal can have an acidic pH. For example, the solution can have an acidic pH of 1.0 to 5.0, 1.0 to 4.0, 1.0 to 3.0, or 1.0 to 2.0. The solution containing the heavy metal can have a basic pH. For example, the solution can have a basic pH 10.0 to 13.0, 11.0 to 13.0, or 12.0 to 13.0. The solution can also contain one or more background metals such as calcium, zinc, magnesium, or sodium. The background metals can be present at a concentration of about 5 ppb, 10 ppb, 15 ppb, 20 ppb, or greater.

### EXAMPLES

Materials, syntheses, and characterization. All starting materials, reagents, and solvents were purchased from commercial sources (Aldrich, Alfa, Fisher, and Acros) and used with-out further purification. Elemental analyses were performed on a Perkin-Elmer 2400 element analyzer. Powder X-ray diffraction (PXRD) data were collected on a Bruker AXS D8 Advance A25 Powder X-ray Diffractometer. N₂ gas sorption experiments were carried out on a Micrometrics ASAP2020 volumetric gas sorption instrument. High-purity grade gases of N₂ (99.999%), C₂H₄ (99.5%), and C₂H₆ (99.5%) were used for the collection of respective sorption isotherms. Thermogravimetric analysis (TGA) was analyzed by a Q50 thermogravimetric analyzer. IR spectra were recorded on a Nicolet Impact 410 FTIR spectrometer. Z-Ray Photoelectron Spectroscopy (XPS) measurements were performed on an ESCALAB 250 X-ray photoelectron spectroscopy, using Mg Kα X-ray as the excitation source. The ¹³C NMR data was collected on a Bruker AVANCE IIIHD console with 1.9 mm MAS probe. The scanning electron microscope analysis was performed on a JEOL JSM-6700F and Hitachi S-4800 field-emission scanning electron microscope (FE-SEM). Inductively coupled plasma (ICP) analysis was performed on a Perkin-Elmer Elan DRC II Quadrupole Inductively Coupled Plasma Mass Spectrometer (ICP-MS) analyzer.

### Example 1

### Materials Preparation and Physicochemical Characterization

PAF-1 [(cross-linked poly-tetraphenylmethane) also known as (a.k.a.) PPN-6] is an amorphous POP possessing a hypothetical diamondoid-topology structure with very high surface area, and exceptional stability in water/moisture and acidic/basic media. PAF-1-SH can be readily achieved by chloromethylation of PAF-1 followed by the treatment with NaH following procedures reported herein.

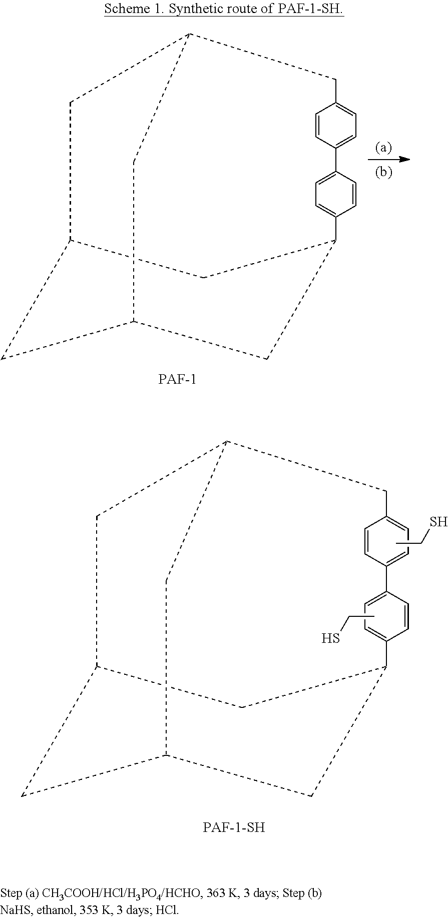

Synthesis of tetrakis(4-bromophenyl)methane. To a three-necked round-bottom flask containing bromine (6.4 mL, 19.9 g), tetraphenylmethane (2.0 g, 6.24 mmol) was added step-wise with small portions under vigorous stirring at room temperature (25° C.). After the addition was completed, the resulting solution was stirred for 60 min and then cooled to 0° C. At 0° C. temperature, ethanol (25 mL) was added slowly and the reaction mixture was allowed to warm to room temperature overnight. Then, the precipitate was filtered off and washed subsequently with saturated aqueous sodium hydrogensulfite solution (25 mL) and water (100 mL). After drying at 80° C. for 24 h under vacuum (80 mbar), tetrakis(4-bromophenyl) methane was recrystallized in EtOH/CH₂Cl₂ to afford a yellow solid, yield: 88%.

Synthesis of PAF-1. Tetrakis(4-bromophenyl)methane (509 mg, 0.8 mmol) was added to a solution of 2,2′-bipyridyl (565 mg, 3.65 mmol), bis(1,5-cyclooctadiene)nickel(0) (1.0 g, 3.65 mmol), and 1,5-cyclooctadiene (0.45 mL, 3.65 mmol) in anhydrous DMF/THF (60 mL/90 mL), and the mixture was stirred overnight at room temperature under nitrogen atmosphere. After the reaction, 6 M HCl (60 mL) was added slowly, and the resulting mixture was stirred for 12 h. The precipitate was collected by filtration, then washed with methanol and water, and dried at 150° C. for 24 h under vacuum (80 mbar) to produce PAF-1 as a white powder, yield: 80%.

Synthesis of PAF-1-SH. A re-sealable flask was charged with PAF-1 (200.0 mg), paraformaldehyde (1.0 g), glacial AcOH (6.0 mL), H₃PO₄ (3.0 mL), and conc. HCl (20.0 mL). The flask was sealed and heated to 90° C. for 3 days. The resulting solid was collected, washed with water and methanol, and then dried under vacuum to produce yellow solid of PAF-1-CH₂Cl. Subsequently the obtained PAF-1-CH₂Cl was mixed with NaHS (1.2 g, 21.0 mmol) in 100 mL EtOH under N₂ and stirred at 75° C. for 3 days. The resulting solid was collected, washed with water and methanol, and then dried under vacuum to produce PAF-1-SH as yellow powder. Elemental Analysis: C: 72.5%; H: 4.24%; S: 17.6%.

Synthesis of MCM-41-SH. The MCM-41-SH was synthesized according to the procedures reported in the literature.⁵⁸ Elemental Analysis: C: 8.54%; H: 1.81; N: 0%; S: 4.99%.

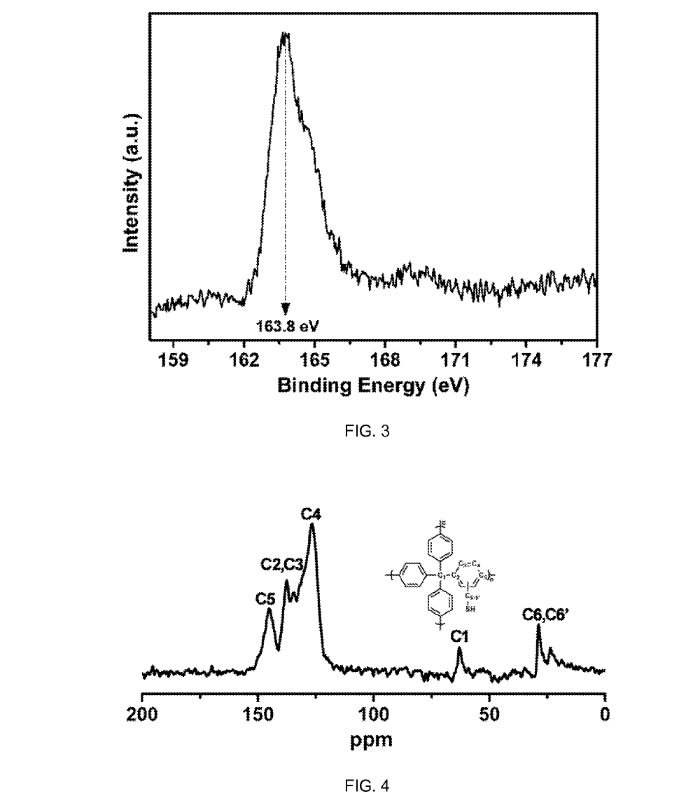

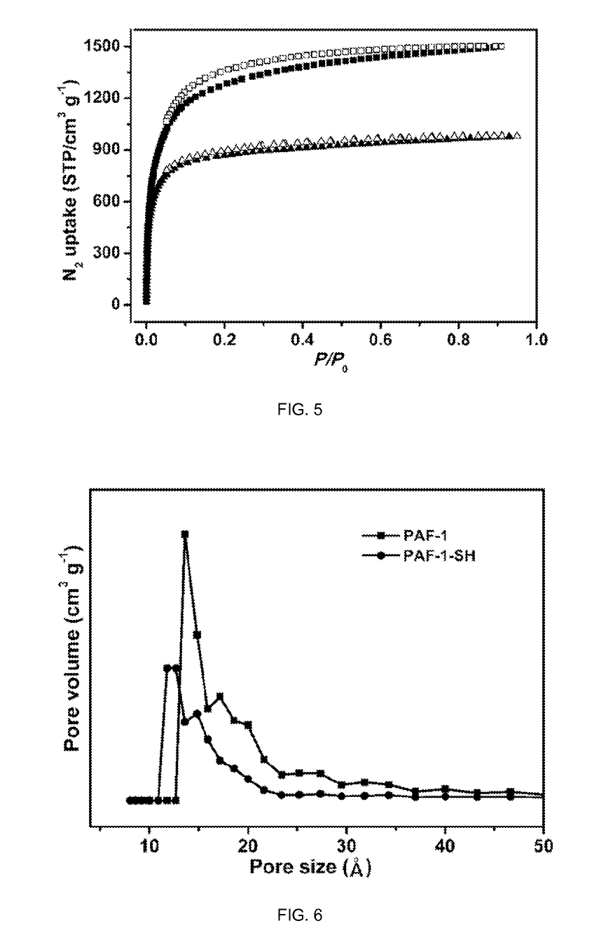

Results and Discussion. The successful grafting of thiol group onto PAF-1 was confirmed by Fourier transform infrared spectroscopy (FT-IR), X-ray photoelectron spectroscopy (XPS), and solid-state ¹³C NMR studies. The FT-IR spectra of the dehydrated PAF-1-SH show the aliphatic C—H stretching bands at 2959 cm⁻¹ and 2928 cm⁻¹ as well as the characteristic band⁴⁷ of S—H at 2576 cm⁻¹ compared with the pristine PAF-1 (FIG. 2). XPS spectra of PAF-1-SH indicate the appearance of sulfur signal at a binding energy of 163.8 eV (FIG. 3), which is consistent with the S(2p) of the thiol group. Solid-state ¹³C NMR studies identify the chemical shifts at 23.0 and 28.9 ppm for the carbon of —CH₂ group (FIG. 4), suggesting the successful attachment of —CH₂SH groups to the phenyl rings in PAF-1. Elemental analysis reveals a sulfur content of 17.6 wt. % corresponding to 5.5 mmol g⁻¹ —SH groups in PAF-1-SH, which indicates 57% of the phenyl rings are grafted with one —CH₂SH group each.

Nitrogen gas sorption isotherms collected at 77 K indicate that the grafting of thiol groups leads to a decrease in the Brunauer-Emmett-Teller (BET) surface area from 4715 m² g⁻¹ for PAF-1 to 3274 m² g⁻¹ for PAF-1-SH and a small reduction in pore size by about 3 Å (FIG. 6). It is worth noting that the surface area of PAF-1-SH is significantly higher than any other thiol-modified porous materials, which usually exhibit moderate surface areas of 500˜2000 m² g⁻¹. In addition, the sulfur content in PAF-1-SH is also remarkably higher compared to thiol group functionalized mesoporous silica MCM-41 (MCM-41-SH) (17.6 wt. % in PAF-1-SH vs. 4.99 wt. % in MCM-41-SH).

### Example 2

### Mercury Binding Affinity and Selectivity

Hg(II) sorption kinetics. A 50 mL aqueous of Hg(NO₃)₂ (10 ppm, pH=6.8 NaH₂PO₄/Na₂HPO₄ buffer) was added to a Erlenmeyer flask. Then 25.0 mg PAF-1-SH sample was added to form a slurry. The mixture was stirred at room temperature for 8 h. During the stirring period, the mixture was filtered at intervals through a 0.45 micron membrane filter for all samples, then the filtrates were analyzed using ICP-MS to determine the remaining Hg(II) content.

Hg(II) sorption isotherm. PAF-1-SH (10.0 mg) were added to each Erlenmeyer flask containing Hg(NO₃)₂ solution (50 mL) with different concentrations. The mixtures were stirred at room temperature for 12 h, and then were filtered separately through a 0.45 micron membrane filter, and the filtrates were analyzed by using ICP-MS to determine the remaining Hg(II) content.

Ion selectivity tests. 50.0 mg PAF-1-SH sample was added into a Erlenmeyer flask containing a 50 mL aqueous solution of Hg(NO₃)₂, Pb(NO₃)₂, NaAsO₂, Cd(NO₃)₂, Zn(NO₃)₂, Ca(NO₃)₂, Mg(NO₃)₂ with sorts of concentration in NaH₂PO₄/Na₂HPO₄ buffer (pH=6.8). The mixture in the form of slurry was stirred at room temperature for 12 h, and then was filtered through a 0.45 micron membrane filter, and the filtrates were analyzed using ICP-MS to determine the contents.

Breakthrough experiments. 100.0 mg PAF-1-SH sample was packed into a pipette to form an adsorption column with inner diameter of ˜3.3 mm and the packed sample length was about 7.8 cm. A aqueous solution (30 ml) of Hg(NO₃)₂, Pb(NO₃)₂, NaAsO₂, Cd(NO₃)₂, Zn(NO₃)₂, Ca(NO₃)₂, Mg(NO₃)₂ with sorts of concentration in NaH₂PO₄/Na₂HPO₄ buffer (pH=6.8) was then passed through the column, and the filtrates were analyzed using ICP-MS to determine the contents.

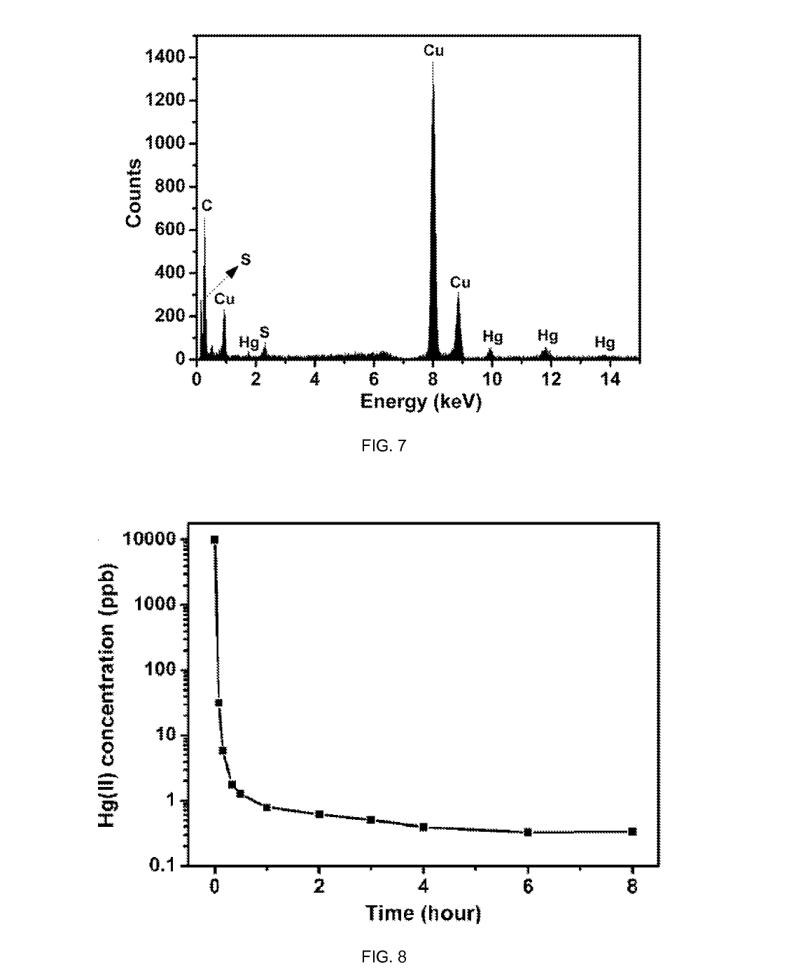

Results and Discussion. To evaluate the effectiveness of PAF-1-SH as mercury “nano-trap” for removing Hg(II) from water, an as-made PAF-1-SH sample was placed in a dilute aqueous solution (pH of 6.8) of Hg(NO₃)₂ with Hg(II) concentration of 10 ppm. The adsorbed Hg(II) was observed by Energy-dispersive X-ray spectroscopy (EDS) spectra and sulfur from the thio group was also detected by EDS (FIG. 7). As shown in FIG. 8, PAF-1-SH can rapidly capture Hg(II) ions; and after ˜6 hours the residual Hg(II) concentration in the solution was smaller than 0.4 ppb, that is, almost 99.997% of the mercury was removed by PAF-1-SH under such condition. It is noteworthy that the residual Hg(II) concentration in the solution treated with PAF-1-SH is 28 times lower than that (0.01 ppm) in the solution treated with the MOF of Zr-DMBD, and is also lower than that in the solution treated with thiol group functionalized FMMS (0.8 ppb), or Chalcogel-1 (0.04 ppm). These results therefore highlight the superior effectiveness of PAF-1-SH for removing Hg(II) from aqueous solutions compared to some benchmark sorbents. Indeed a single treatment highly contaminated water with PAF-1-SH can effectively reduce the mercury concentration to well below U.S. Environmental Protection Agency elemental limits for hazardous wastes and even the acceptable limits in drinking water standards (<2 ppb). PAF-1-SH is highly effective for mercury removal from aqueous solutions. This may be attributable to its high affinity for Hg(II) as a result of the highly accessible thiol groups that are densely populated throughout the inner surface of PAF-1-SH.

One measure of a sorbent's affinity for a target metal ion is the distribution coefficient (K_{d}) measurement. The K_{d} is defined as:

$${K}_{d} = \frac{( {C}_{i} - {C}_{f} )}{{C}_{f}} \times \frac{V}{m} \qquad ( 1 )$$

where Cᵢ is the initial metal ion concentration, C_{f} is the final equilibrium metal ion concentration, V is the volume of the treated solution in mL, and m is the mass of the sorbent used in mg. The K_{d} can be used to characterize any sorbents performance metrics of metal ion adsorption, and K_{d} values of 1.0×10⁵ mL g⁻¹ are usually considered excellent. The K_{d} of PAF-1-SH for Hg(II) has been measured to be exceptional with a value of 5.76×10⁷ mL g⁻¹. This value is among the highest for sorbent materials for Hg(II) adsorption reported thus far, and exceeds that reported for a series of benchmark materials, e.g. commercial resins (10⁴˜5.10×10⁵ mL g⁻¹), FMMS (3.4×10⁵˜1.68×10⁷ mL g⁻¹), thiopyrene functionalized mesoporous carbon (6.82×10⁵ mL g⁻¹), LHMS-1 (6.4×10⁶ mL g⁻¹), Chalcogel-1 (1.61×10⁷ mL g⁻¹), the MOF of Zr-DMBD (9.99×10⁵ mL g⁻¹).

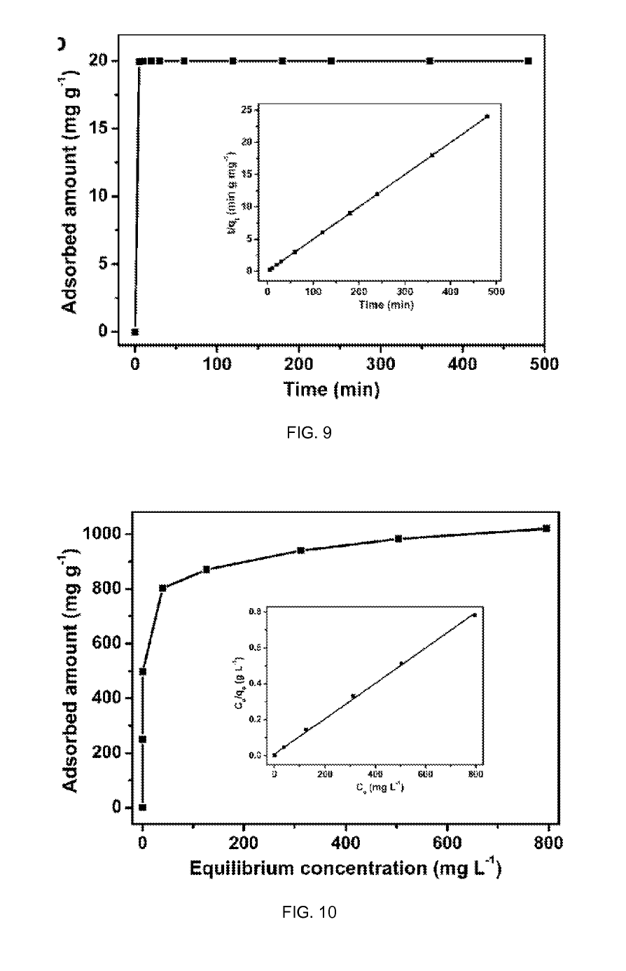

The efficacy of PAF-1-SH as mercury “nano-trap” for removing Hg(II) from aqueous solutions has been examined by investigating the mercury adsorption kinetics of PAF-1-SH (25.0 mg) in 10 ppm solution (pH of 6.8) of Hg(NO₃)₂ (50.0 ml). As shown in FIG. 9, extremely fast kinetics are observed for PAF-1-SH, which can attain 99.9% of the adsorption capacity at equilibrium within 7 min and is able to reduce a heavily contaminated water with the Hg(II) concentration of 10 ppm to the acceptable limit of 2 ppb for drinking water within less than 20 min of PAF-1-SH/water contact (FIG. 8). Considering the great reliability to represent the kinetics for the adsorption of heavy metal ions from aqueous solutions onto adsorbents, the experimental data was fitted with the pseudo-second-order kinetic model using the following equation:

$$\frac{t}{{q}_{t}} = \frac{1}{{k}_{2} {q}_{e}^{2}} + \frac{t}{{q}_{e}} \qquad ( 2 )$$

where k₂ (g mg⁻¹ min⁻¹) is the rate constant of pseudo-second-order adsorption, qₜ (mg g⁻¹) is the amount of Hg(II) adsorbed at time t (min), and qₑ (mg g⁻¹) is the amount of Hg(II) adsorbed at equilibrium. An extremely high correlation coefficient (>0.9999) was obtained (FIG. 9), and the value of the adsorption rate constant k₂ was determined to be 8.13 g mg⁻¹ min⁻¹. This value is one or two order-of-magnitude higher than other adsorbent materials for Hg(II) adsorption under similar conditions. The extraordinarily fast kinetics observed for PAF-1-SH might be ascribed to its large pore size. The pore size can facilitate the diffusion of Hg(II) ions and its high surface area densely populated with thiol groups.

To assess the mercury uptake capacity of PAF-1-SH, which is also an important aspect of sorbent's performance metrics, adsorption isotherm for Hg(II) removal from water (pH of 6.8) was collected (FIG. 10). The equilibrium adsorption isotherm data were fitted with Langmuir model yielding a high correlation coefficient (>0.9984) (See insert of FIG. 10). Remarkably, the maximum mercury adsorption capacity of PAF-1-SH was calculated to be 1014 mg g⁻¹ (˜5.1 mmol g⁻¹). This corresponds to capture of 0.927 Hg(II) ion per thiol group in PAF-1-SH, suggesting the accessibility of almost all thiol groups in PAF-1-SH for Hg(II) ions. To the best of our knowledge, the maximum mercury uptake capacity of PAF-1-SH is the highest among adsorbent materials reported thus far for mercury adsorption, and is significantly higher than that of some benchmark thiol/thio functionalized porous materials, e.g. thiol-monolayer functionalized mesoporous silica (505-600 mg g⁻¹), thiopyrene featured porous carbon (518 mg g⁻¹), Chalcogel-1 (645 mg g⁻¹), MOF Zr-DMBD (197 mg g⁻¹). Such an outstanding saturation mercury uptake capacity may be attributed to the high surface area together with a large number of highly accessible thiol groups that are well dispersed throughout the inner surface of PAF-1-SH.

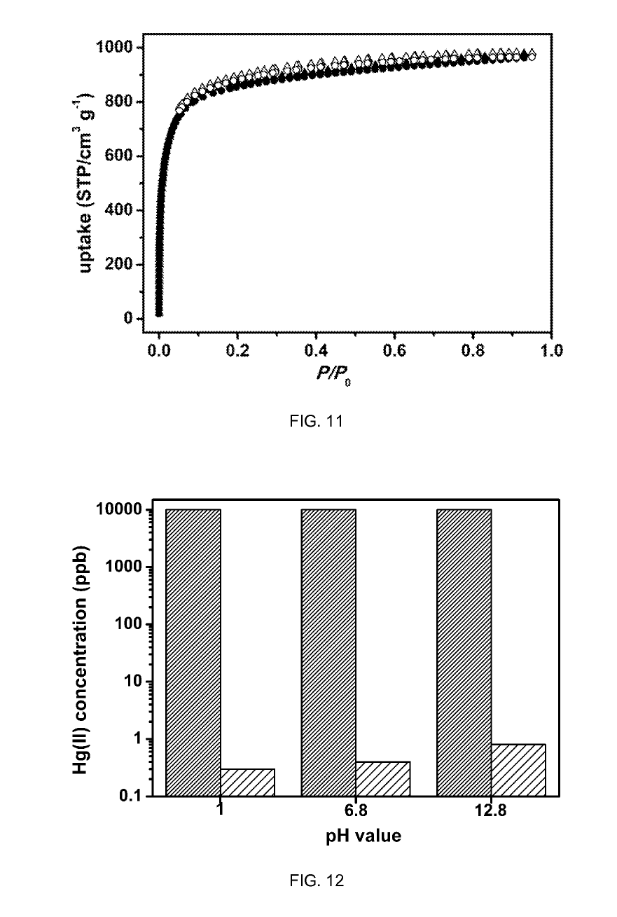

The ability to withstand a variety of harsh chemical conditions (e.g. extreme pH) and still effectively adsorb Hg(II) is highly desirable for a material in practical application of decontaminating Hg(II) from aqueous media. The chemical/water stability of PAF-1-SH was verified by virtually no surface area drop after PAF-SH-1 sample was treated successively with 2.0 M NaOH, 2.0 M HCl and boiling water, as revealed by N₂ sorption isotherms collected at 77 K (FIG. 11). This represents an advantage of PAF-1-SH for mercury removal across a wide range of pH, particularly when compared with silica and MOFs-based adsorbents that usually suffer from the loss of porosity under such harsh conditions. Mercury adsorption experiments under acidic and basic conditions revealed that PAF-1-SH also exhibits high affinities for Hg(II) with K_{d} values of 6.66×10⁷ mL g⁻¹ at pH 1.0 and 2.49×10⁷ mL g⁻¹ at pH 12.8, which render excellent capability of reducing Hg(II) concentrations from 10 ppm to lower than 0.3 ppb at pH 1.0 and lower than 0.8 ppb at pH 12.8 (FIG. 12). These results highlight the effectiveness of PAF-1-SH as mercury “nano-trap” for removing Hg(II) from aqueous media over a broad range of pH values.

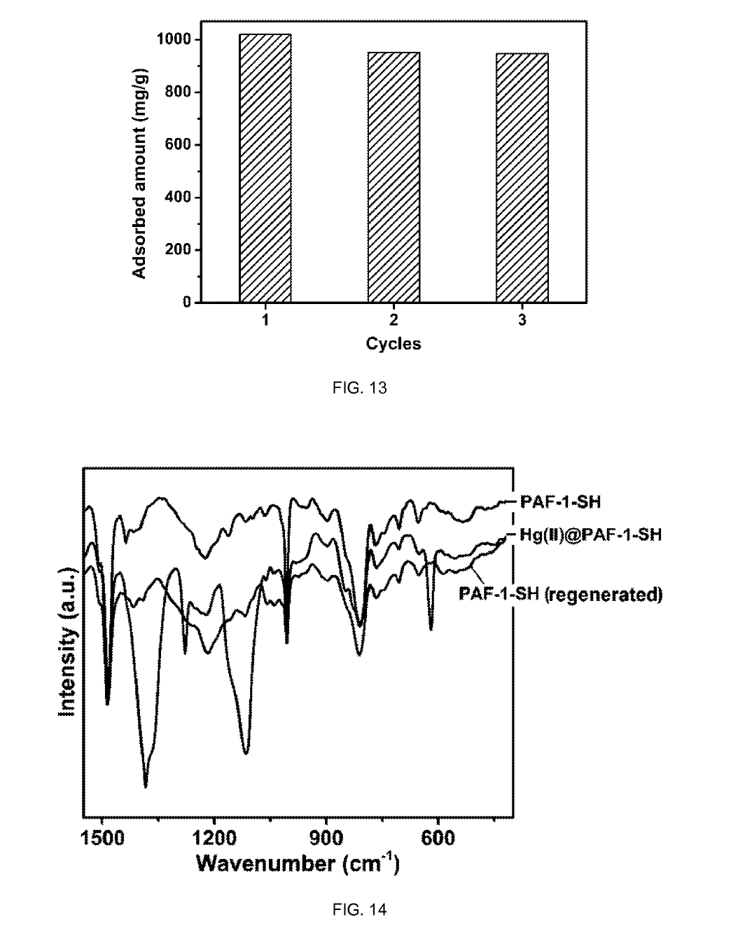

The mercury-loaded PAF-1-SH can be regenerated by washing with a concentrated HCl (12.0 M) solution, which results in 100% removal of the loaded mercury. The regenerated PAF-1-SH retained >90% of the original loading capacity even after several regeneration and reuse cycles (FIG. 13). It might be reasoned that such excellent recyclability with negligible loss of mercury adsorption capacity observed for PAF-1-SH could be attributed to the well dispersive distribution of thiol groups throughout its highly porous framework structure thus minimizing the formation of the weaker binding S—S units as a result from the oxidation —SH groups. This is supported by the absence of S—S stretching bands (500-540 cm⁻¹) in the FT-IR spectra of regenerated PAF-1-SH (FIG. 14).

The selectivity tests were also performed on PAF-1-SH in a Hg(II) solution containing Pb(II), Cd(II), As(III), Ca(II), Mg(II), Zn(II) and Na(I) ions (Table 1). PAF-1-SH not only can effectively adsorb Hg(II), but also can largely remove other highly toxic heavy metal ions of Pb(II) and Cd(II). In contrast, other background metal ions such as Ca(II), Zn(II), Mg(II) and Na(I) do not quite bind to PAF-1-SH, and PAF-1-SH can remain effective in the presence of high concentrations of these ions. Similar results (Table 2) were also obtained in the breakthrough experiments of passing the mixture solution of these ions through a column packed with PAF-1-SH. Similar to FMMS, the high selectivity of Hg(II) and other heavy metal ions of Pb(II) and Cd(II) against the background metal ions of Ca(II), Zn(II), Mg(II) and Na(I) observed for PAF-1-SH should stem from the strong soft-soft interactions between Hg(II)/Pb(II)/Cd(II) ions and the thiol groups within PAF-1-SH. PAF-1-SH also exhibits low binding ability for As(III), and this could be due to that As(III) is non-metal ion and exists in the form of AsO₂⁻ in aqueous solution, which can hardly interact with the thiol group strongly.

TABLE 1
Concentrations of metal ions before and after the treatment of PAF-1-SH.

| | Concentration (ppm) | | | | | | | |
|---|---|---|---|---|---|---|---|---|
| Solution | Hg(II) | Pb(II) | Cd(II) | As(III) | Ca(II) | Zn(II) | Mg(II) | Na(I) |
| Before | 3.12 | 2.52 | 1.62 | 0.94 | 0.61 | 0.95 | 0.36 | 8223 |
| treatment | | | | | | | | |
| After treatment | 0.0003 | 0 | 0.042 | 0.78 | 0.52 | 0.58 | 0.31 | 8211 |

TABLE 2
Concentrations of metal ions before and after the breakthrough
experiments of PAF-1-SH.

| | Concentration (ppm) | | | | | | | |
|---|---|---|---|---|---|---|---|---|
| Solution | Hg(II) | Pb(II) | Cd(II) | As(III) | Ca(II) | Zn(II) | Mg(II) | Na(I) |
| Before | 3.12 | 2.52 | 1.62 | 0.94 | 0.61 | 0.95 | 0.36 | 8223 |
| breakthrough | | | | | | | | |
| After | 0 | 0 | 0.025 | 0.73 | 0.45 | 0.44 | 0.28 | 8193 |
| breakthrough | | | | | | | | |

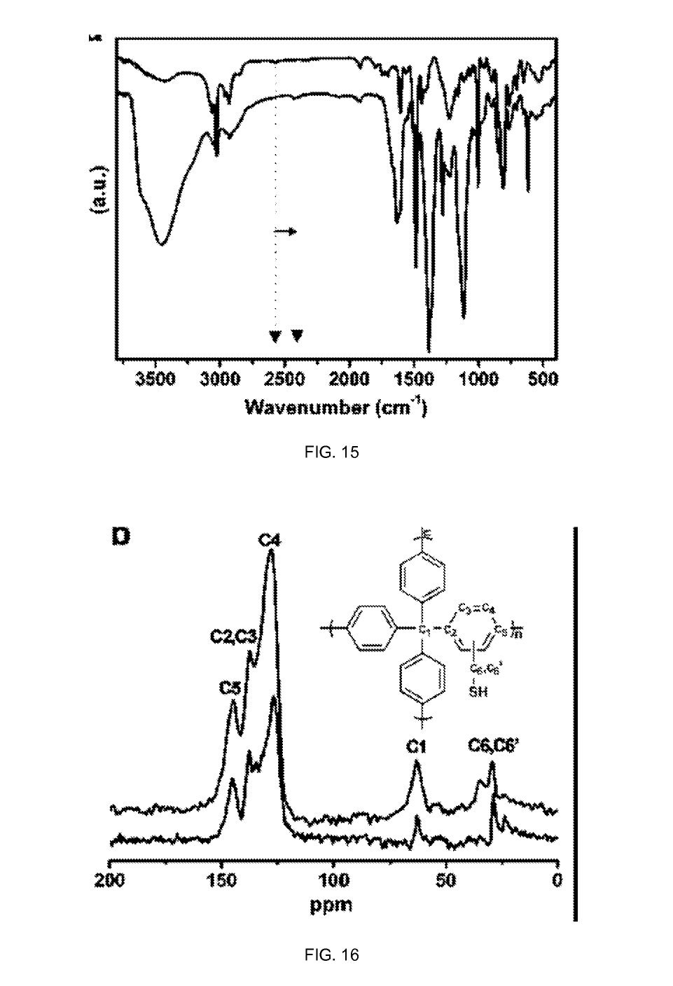

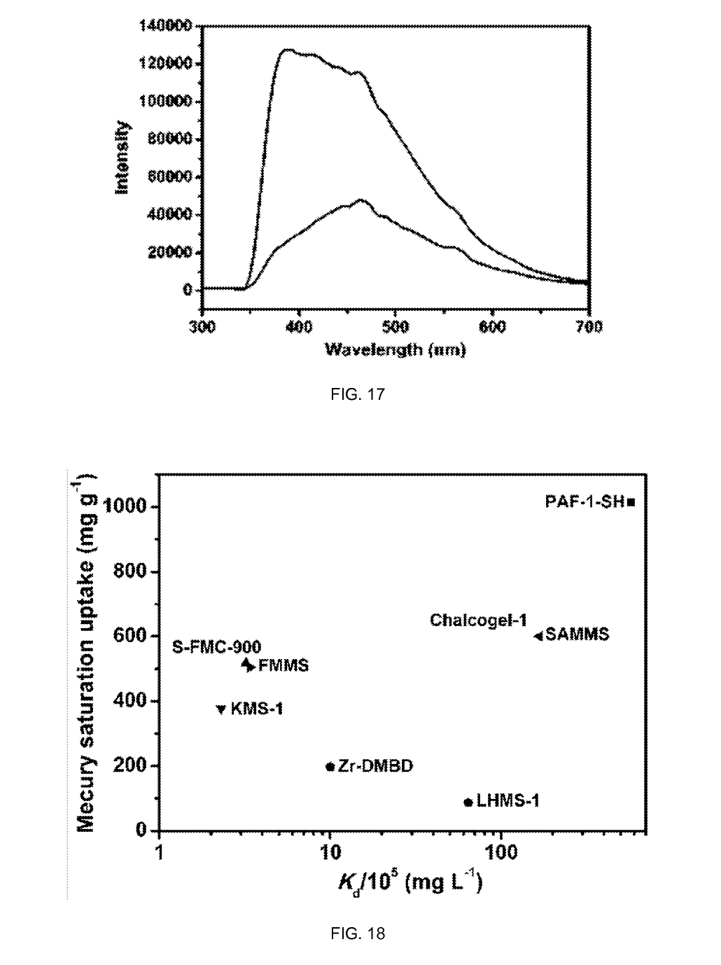

The outstanding performances of PAF-1-SH as mercury “nano-trap” may be traceable to the strong binding interactions between Hg(II) and thiol group in PAF-1-SH, which have been elucidated by FT-IR, NMR, and photoluminescence (PL) studies. As shown in FIG. 15, IR spectra reveal a large shift of S—H stretch mode from 2576 cm⁻¹ in PAF-1-SH to 2380 cm⁻¹ in the Hg(II)-loaded PAF-1-SH, indicating the formation of strong binding interactions between Hg(II) and thio group. The formation of strong chemical bonding between the mercury and thiol group is also suggested by solid state ¹³C NMR spectrum for Hg(II)-loaded PAF-1-SH (FIG. 16), which indicates a large shift of 6 ppm for the peak corresponding to the carbon (C6/C6′) attached to the thiol group. The strong binding interactions between Hg(II) and thiol group in PAF-1-SH is further evidenced by PL studies, which reveal that the PL intensity of PAF-1-SH host framework is greatly impacted by the Hg(II) uptake. As shown in FIG. 17, the as-made sample features a broad emission centered around 420 nm, and the PL intensity is largely suppressed upon the loading of Hg(II), being less than ⅓ of the intensity for the host PAF-1-SH.

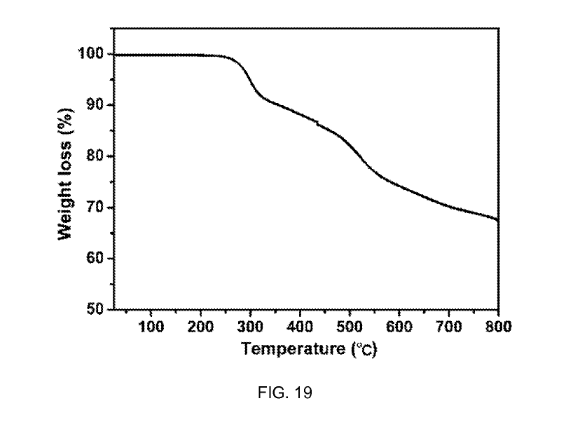

To evaluate a material for mercury removal from aqueous solutions, the distribution coefficient (K_{d}) and saturation uptake capacity have been deemed as two most important criteria, and high values for both of them are needed to achieve high effectiveness and high efficiency for mercury removal. Exceptional distribution coefficient for Hg(II) and extraordinary mercury saturation uptake capacity have both been demonstrated in the POP-based mercury “nano-trap” of PAF-1-SH as reported herein, which sets a new benchmark for mercury adsorbent materials (FIG. 18). The issues of structure stability under harsh chemical conditions, decreasing mercury affinity over a broad range of pH and loss of mercury uptake capacity upon regeneration represent some barriers for most mercury adsorbent materials to be applied in practical application of decontaminating Hg(II) from aqueous media; these issues have also been well addressed in the POP-based mercury “nano-trap” of PAF-1-SH. A high selectivity of Hg(II) against a series of trace metal ions [e.g. Ca(II), Zn(II), Mg(II), Na(I)] represents another necessary consideration for mercury removal from aqueous solutions in reality, and this has been well demonstrated by the POP-based mercury “nano-trap” of PAF-1-SH as well. The decent thermal stability up to 270° C. (FIG. 19) for PAF-1-SH suggests its capability for mercury vapor sorption which is related to the industrial processes of flue gas detoxification. The mercury “nano-traps” can be readily achieved in other POPs that are constructed from various organic building blocks derived from a variety of resources through economical reaction processes, thus making “nano-traps” a class of materials for mercury removal.

A mercury “nano-trap” is demonstrated for highly effective and highly efficient removal of Hg(II) from aqueous solutions as exemplified in the context of thiol functionalized POP of PAF-1, PAF-1-SH. PAF-1-SH exhibits very high affinity for Hg(II) with an exceptional distribution coefficient value of 5.76×10⁷ mL g⁻¹, extremely fast kinetics for Hg(II) adsorption with an extraordinary pseudo-second-order adsorption rate constant of 8.31 g mg⁻¹ min⁻¹, and record-high saturation mercury uptake capacity of 1014 mg g⁻¹. As mercury “nano-trap”, PAF-1-SH not only can effectively reduce Hg(II) concentration from 10 ppm to the extremely low level of smaller than 0.4 ppb well below the acceptable limits in drinking water standards (<2 ppb) and efficiently remove >99.9% mercury(II) within a few minutes, but also can retain high effectiveness for mercury removal over a very broad pH range and maintain high mercury adsorption capacity upon regeneration and reuse; in addition, it can remain effective in the presence of high concentrations of background metal ions of Ca(II), Zn(II), Mg(II) and Na(I). The approach of creating mercury “nano-traps” based upon highly porous and highly robust POPs thereby provides a material for decontaminating Hg(II) from aqueous media. Moreover, the “nano-traps” advanced herein can also be readily applied to capturing other heavy metal ions from contaminated water for environmental remediation as demonstrated here.

1. A composition for binding a heavy metal, the composition comprising a porous organic polymer (POP) having incorporated therein a plurality of heavy metal chelator moieties.

2. The composition of claim 1, wherein the heavy metal is selected from the group consisting of antimony, arsenic, barium, cadmium, chromium, cobalt, copper, gold, lead, mercury, nickel, palladium, platinum, rhodium, selenium, silver, thallium, and zinc.

3. The composition of claim 1, wherein the heavy metal is mercury.

4. The composition of claim 1, wherein the composition has a maximum metal uptake capacity of 500 mg g⁻¹ to 2,000 mg g⁻¹ at 1 atm and 296 K.

5. The composition of claim 1, wherein the composition has a distribution coefficient for the heavy metal of 1×10⁷ mL g⁻¹ to 1×10⁹ mL g¹.

6. The composition of claim 1, wherein the composition attains at least 90% of the equilibrium adsorption capacity in less than 10 minutes when placed in an aqueous solution containing the heavy metal.

7. The composition of claim 1, wherein the composition has a metal uptake capacity that is stable and recyclable.

8. The composition of claim 1, wherein the porous organic polymer is stable under basic conditions.

9. The composition of claim 1, wherein the porous organic polymer has a surface area from 20 m²/g to 8,000 m²/g.

10. The composition of claim 1, wherein the porous organic polymer has a pore size from 1 angstrom to 500 angstroms.

11. The composition of claim 1, wherein the porous organic polymer comprises a monomer unit comprising an aryl moiety.

12. The composition of claim 1, wherein the aryl moiety is selected from the group consisting of substituted and unsubstituted benzene, naphthalene, anthracene, biphenyl, pyridine, pyrimidine, pyridazine, pyrazine and triazine.

13. The composition of claim 1, wherein the porous organic polymer is selected from the group consisting of a conjugated microporous polymer, a porous aromatic framework, a porous polymer network, and a porous organic framework.

14. The composition of claim 1, wherein the porous organic polymer is a porous aromatic framework.

15. The composition of claim 1, wherein the porous aromatic framework comprises cross-linked poly-tetraphenylmethane.

16. A method of making the composition of claim 1, the method comprising:
synthesizing a porous organic polymer; and
grafting heavy metal chelator moieties onto the porous organic polymer.

17. A method of removing a heavy metal from a solution comprising contacting an effective amount of the composition of claim 1 with the solution.

18. The method of claim 17, wherein the initial concentration of the heavy metal in the solution is 1 ppm to 100 ppm and the final concentration of the heavy metal in the solution is 0.2 ppb to 2.0 ppb.

19. The method of claim 17, wherein the solutions contains one or more background metals selected from the group consisting of calcium, zinc, magnesium, and sodium.

20. The method of claim 17, wherein the solution has an acidic pH of 1.0 to 3.0 or a basic pH of 11.0 to 13.0.
